(19) United States
(12) Patent Application Publication
(10) Pub. No.: US 2011/0043123 A1
(43) Pub. Date: Feb. 24, 2011

(54) ELECTRODELESS PLASMA LAMP AND FILL

(76) Inventors: Richard Gilliard, Morgan Hill, CA (US); Abdeslam Hafidi, Cupertino, CA (US)

Correspondence Address: SCHWEGMAN, LUNDBERG & WOESSNER, P.A., P.O. BOX 2938, MINNEAPOLIS, MN, 55402, US

(21) Appl. No.: 12/445,637

(22) PCT Filed: Oct. 16, 2007
(86) PCT No.: PCT/US07/81534

§ 371 Date: Nov. 8, 2010

Related U.S. Application Data
(60) Provisional application No. 60/852,291, filed on Oct. 16, 2006.
(60) Provisional application No. 60/852,288, filed on Oct. 16, 2006.

(51) Int. Cl. H05B 41/24

(52) U.S. Cl. 315/248

(57) ABSTRACT

Electrodeless plasma lamp and fill is described. Power may be over coupled to the lamp during startup and a significant percentage of the power is reflected. In some examples, 40-80% of the power may be initially reflected and less than 100 watts of forward power may be provided to the lamp. A high pressure fill is used to increase resistance and coupling of power during startup. In one example, a fill of noble gas, Mercury and metal halide is used and the high pressure decreases the warm up time required to vaporize the Mercury and metal halide. In some embodiments, the pressure may be between 200 Torr to 3000 Torr. A combination of metal halides may be used to provide desired characteristics. For example, Aluminum Halide, Indium Halide and/or Thallium Halide may be combined with one or more metal halides having a metal from the Lanthanide series.

### CROSS REFERENCE TO RELATED APPLICATIONS

This application claims the benefit of priority to both U.S. Provisional Application No. 60/852,291, entitled “PLASMA LAMP WITH ENHANCED SPECTRUM,” filed on Oct. 16, 2006 and U.S. Provisional Application No. 60/852,288, entitled “ELECTRODELESS PLASMA LAMP WITH RAPID WARM UP,” filed Oct. 16, 2006. The entire contents of both applications are incorporated herein by reference.

### BACKGROUND

I. Field

The field relates to systems and methods for generating light, and more particularly to electrodeless plasma lamps.

II. Background

Electrodeless plasma lamps may be used to provide bright, white light sources. Because electrodes are not used, they may have longer useful lifetimes than other lamps. In an electrodeless plasma lamp, radio frequency power may be coupled into a fill in a bulb to create a light emitting plasma. However, as the fill is ignited and the plasma heats up, the load conditions of the lamp may change. In some plasma lamps, these conditions may make it difficult to reach full brightness quickly while also allowing power to be efficiently coupled during steady state operation. In addition, some fills used in plasma lamps produce an unbalanced spectrum and may not be bright enough in certain color bands at desired power levels. In some applications, such as projection displays, this may cause color balancing or brightness problems.

What is desired are improved systems and methods for startup and operation of an electrodeless plasma lamp. What is also desired are fills for an electrodeless plasma lamp that facilitate rapid startup of the lamp and fills that provide an improved spectrum, lifetime and/or brightness.

### SUMMARY

Example embodiments provide systems and methods for startup and operation of an electrodeless plasma lamp and/or for enhanced fills. In one embodiment, a radio frequency (RF) feed is coupled to the lamp body to provide power for ignition and steady state operation of the lamp. Feedback is used to adjust frequency in response to changing conditions of the lamp during startup. A phase shifter is used to adjust the phase of the power between ignition and steady state operation.

In some example embodiments, RF power is provided to the lamp body and fill in the bulb at a frequency in the range of between about 50 MHz and about 30 GHz, or any range subsumed therein. In some examples, the frequency is less than 1 GHz. In an example embodiment, the RF power causes a light emitting plasma discharge in the bulb. In example embodiments, RF power is coupled by radiating RF power into a lamp body and establishing a standing wave. In some embodiments, RF power may be provided at or near a resonant frequency for the load formed by the lamp body, bulb and fill.

In some example embodiments, the lamp body includes a solid dielectric body with an electrically conductive coating. In example embodiments, power is coupled from the lamp body to the bulb through an uncoated dielectric surface adjacent to the bulb. In example embodiments, the surface area through which power is coupled to the bulb is relatively small. In some embodiments, the surface area is in the range of about 5%-50% of the outer surface area of the bulb or any range subsumed therein. In some examples, the surface area is less than 25% of the outer surface area of the bulb. In some embodiments, the surface area is less than 100 mm². In other examples, the surface area is less than 75 mm², 50 mm² or 35 mm². In some embodiments, the surface area is disposed symmetrically around a middle region of the bulb and is spaced apart from the ends of the bulb. In some examples, each interior end of the bulb is spaced from the edge of the closest uncoated surface area by a distance in the range of 1 mm to 15 mm or any range subsumed therein. In some embodiments, this allows power to be concentrated in a narrow region in the middle of the bulb and a small arc length is formed that does not impinge on the ends of the bulb. In some examples, the arc length is less than about 20% to 75% of the interior length of the bulb or any range subsumed therein. In some examples, the arc length is within the range of 2 mm to 5 mm or any range subsumed therein. In some example embodiments, the interior of the bulb has a volume in the range of about 10 mm³ to 750 mm³ or any range subsumed therein. In some examples, the bulb has an interior volume of less than about 100 mm³ or less than about 50 mm³.

In some example embodiments, power is over coupled to the lamp body and bulb during warm up and a significant percentage of the power is reflected. In some examples, 40%-80% of the power (or any range subsumed therein) may be initially reflected which reduces the amount of power available for warm up and vaporization of the fill in the bulb.

In some example embodiments, a high pressure fill is used to increase impedance and coupling of power during warm up. In one example, a high pressure fill is used to improve coupling of power to the fill during warm up when power is overcoupled. In example embodiments, the impedance of the lamp body and fill during warm up of the plasma (after ignition and before high brightness is achieved) is in the range of 3-50 ohms or any range subsumed therein. In a particular embodiment, the impedance is about 10 ohms during warm up. In example embodiments, the impedance after warm up is in the range of 40-60 ohms or any range subsumed therein. In a particular embodiment, the impedance is about 50 ohms during steady state operation.

In some example embodiments, the fill comprises a gas at a pressure greater than 200 Torr. In some embodiments, the pressure may be between 200 Torr to 3000 Torr or any range subsumed therein. In particular examples, the gas is a noble gas such as Argon or Krypton and the pressure is between 400 Torr and 760 Torr. The above pressures are measured at room temperature and are examples only. In example embodiments, the fill may also include Mercury and a metal halide. In example embodiments, the fill may also include a radioactive ignition enhancer. In example embodiments, the fill includes 1 to 100 micrograms of metal halide per mm³ of bulb volume, or any range subsumed therein, and 1 to 100 micrograms of Mercury per mm³ of bulb volume, or any range subsumed therein. In some embodiments, a radioactive ignition enhancer may be used in the range of from about 5 nanoCurie to 1 microCurie, or any range subsumed therein. These doses are examples only and other embodiments may use different doses and/or different fill materials.

Example embodiments also provide a method for rapidly starting a plasma lamp. In example embodiments, radio frequency power is applied to a solid dielectric lamp body. In a particular embodiment, power is provided by an RF power amplifier at or near a resonant frequency for the lamp body. In example embodiments, the RF power may be applied at a resonant frequency or in a range of from 0% to 10% above or below the resonant frequency or any range subsumed therein. In example embodiments, power is sampled from the lamp body and provided to the amplifier as feedback to adjust the power as the load conditions of the lamp change. Prior to ignition and breakdown of the gas in the bulb, substantially all of the power is reflected. In one example, forward power of between about 100-200 watts is provided, or any range subsumed therein, and the gas in the bulb rapidly breaks down.

In some embodiments, the fill includes a noble gas at a pressure of more than 200 Torr. Mercury and metal halide is used to provide a desired impedance during warm up. In particular examples, Argon is used at a pressure of between about 400 Torr to 700 Torr, or any range subsumed therein. In example embodiments, the vaporization of the Mercury and metal halide is accelerated by use of high pressure noble gas or other substantially non-reactive gas. After ignition in some embodiments, the impedance of the lamp body and plasma during warm up is in the range of about 3-50 ohms or any range subsumed therein. In some examples, the impedance is about 10 ohms prior to transition to high brightness. In some examples, the power is overcoupled during warm up. In some examples, the net power during warm up is in the range of about 40-80 watts, or any range subsumed therein, and the percentage of reflected power during warm up is in the range of about 40-80% of the forward power, or any range subsumed therein. In some examples, the plasma warms up and transitions to high brightness within 1-10 seconds or any range subsumed therein, even when there is significant reflected power and net power of less than 100 watts during warm up.

In some examples, a lamp operating condition is detected to determine when the lamp transitions to high brightness and the lamp drive circuit is adjusted in response to the detected lamp operating condition. In example embodiments, the phase shift in the feedback loop may be adjusted after warm up. In some embodiments, the DC current may also be adjusted after warm up. In example embodiments, the DC current is maintained at a lower level during warm up and is increased after warm up. In one example, the DC current is less than about 8 Amperes during warm up and more than about 8 Amperes after warm up. In example embodiments, the impedance increases after warm up. In some embodiments, the impedance during steady state operation is more than 25 ohms or more than 40 ohms. In some examples, the impedance is about 50 ohms and is matched to the output impedance of the amplifier. In some examples, power is at or near critical coupling for the lamp body and plasma during steady state operation.

In some embodiments, the warm up time for a lamp with a fill including a high pressure noble gas is substantially lower than if a fill with the same noble gas was used at a pressure lower than 200 Torr. In some examples, the warm up time is 10, 20, 50 or even 100 times less than if a lower pressure gas was used. In one example, the warm up time is less than about 15 seconds using a high pressure fill and would be longer than a minute using the same fill at a pressure less than 200 Torr.

In some example embodiments, the fill includes a first metal halide in the range from about 0.03 mg to 0.3 mg or any range subsumed therein, and a second metal halide in the range from about 0.03 mg to 0.3 mg or any range subsumed therein. In some example embodiments, the ratio of the first metal halide to the second metal halide may be 10:90, 20:80, 30:70, 40:60, 60:40, 70:30, 80:20 or 90:10.

In some example embodiments, the first metal halide is Aluminum Halide, Gallium Halide, Indium Halide or Thallium Halide (or a combination of Aluminum Halide, Gallium Halide, Indium Halide and/or Thallium Halide). In some example embodiments, the second metal halide is Holmium Halide, Erbium Halide or Thulium Halide (or a combination of one or more of these metal halides). In these examples, the first metal halide may be provided in a dose amount in the range of about 0.3 mg/cc to 3 mg/cc or any range subsumed therein and the second metal halide may be provided in a dose amount in the range of about 0.15 mg/cc to 1.5 mg/cc or any range subsumed therein. In some example embodiments, the first metal halide is provided in a larger dose amount than the second metal halide.

In some example embodiments, the power is in the range of about 150 to 200 watts. In some example embodiments, the wall loading of the bulb may be 1 watts per mm² (100 watts per cm²) or more. A thermally conductive material, such as alumina powder, may be in contact with the bulb to allow high wall loading to be used as described below. In some example embodiments, the luminous efficiency may be 100 lumens per watt or more. Example embodiments may also provide at a correlated color temperature of 4000 to 10000 K (or any range subsumed therein) with a bulb geometry enabling the collection of 4500 to 5500 lumens (or any range subsumed therein) in 27 mm² steradian when operated at 150 to 200 watts (or any range subsumed therein). In some example embodiments, the fill may be selected to provide a correlated color temperature in the range of 6000 to 9000 K.

It is understood that each of the above aspects of example embodiments may be used alone or in combination with other aspects described above or in the detailed description below. A more complete understanding of example embodiments and other aspects and advantages thereof will be gained from a consideration of the following description read in conjunction with the accompanying drawing figures provided herein. In the figures and description, numerals indicate the various features of example embodiments, like numerals referring to like features throughout both the drawings and description.

### BRIEF DESCRIPTION OF THE DRAWINGS

FIG. 1A is a cross-section and schematic view of a plasma lamp according to an example embodiment.

FIG. 1B is a perspective cross section view of a lamp body with a cylindrical outer surface according to an example embodiment.

FIG. 1C is a perspective cross section view of a lamp body with a rectangular outer surface according to an alternative example embodiment.

FIG. 2A is a side cross section of a bulb according to an example embodiment.

FIG. 2B illustrates the resistance of a noble gas after breakdown at a pressure less than 200 Torr.

FIG. 2C illustrates the resistance of a noble gas after breakdown at a pressure of more than 400 Torr.

FIG. 2D is a chart showing the startup time for an example low pressure fill.

FIG. 2E is a chart showing the startup time for an example high pressure fill according to an example embodiment.

FIG. 2F is a chart showing the changes in startup time for example high pressure fills of 400 Torr and 600 Torr during a burn-in process.

FIG. 2G is a side cross section of a bulb with a tail according to an example embodiment.

FIG. 2H illustrates the spectrum produced by a fill according to an example embodiment.

FIG. 2I is a color chart showing the white point for an example embodiment.

FIG. 3 is a flow chart of a method for starting an electrodeless plasma lamp with a Noble gas, Mercury and metal halide fill according to an example embodiment.

FIG. 4 is a block diagram of control electronics for an electrodeless plasma lamp according to an example embodiment.

### DETAILED DESCRIPTION

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

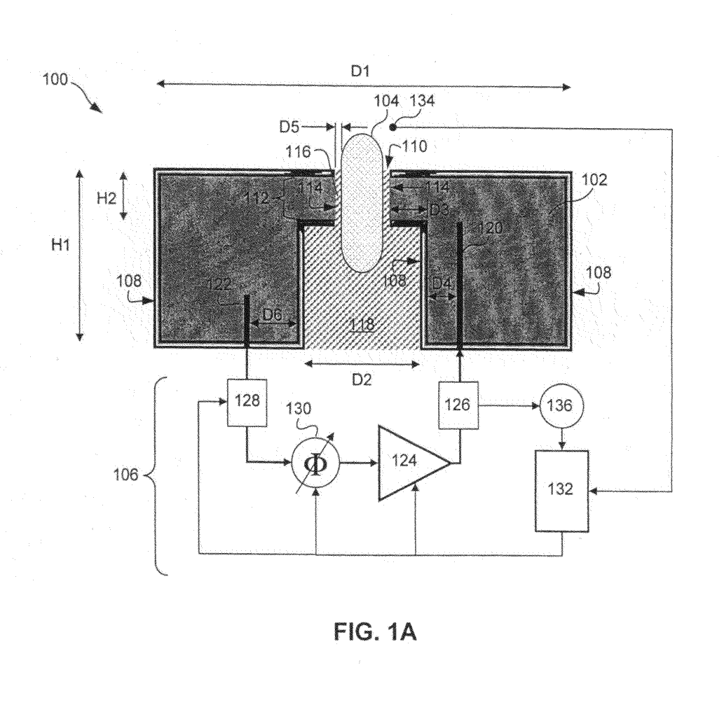

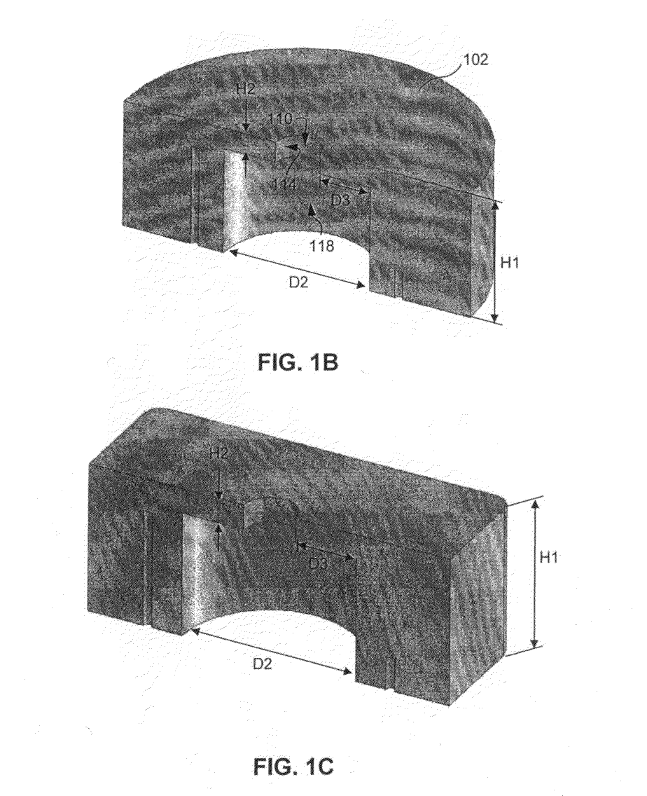

FIG. 1A is a cross-section and schematic view of a plasma lamp 100 according to an example embodiment. This is an example only and other plasma lamps may be used with other embodiments, including microwave or inductive plasma lamps. In the example of FIG. 1A, the plasma lamp may have a lamp body 102 formed from one or more solid dielectric materials and a bulb 104 positioned adjacent to the lamp body. The bulb contains a fill that is capable of forming a light emitting plasma. A lamp drive circuit 106 couples radio frequency power into the lamp body 102 which, in turn, is coupled into the fill in the bulb 104 to form the light emitting plasma. In example embodiments, the lamp body 102 forms a waveguide that contains and guides the radio frequency power. In example embodiments, the radio frequency power may be provided at or near a frequency that resonates within the lamp body 102. This is an example only and some embodiments may use a different electrodeless plasma lamp, such as a capacitively or inductively coupled plasma lamp, or other high intensity discharge lamp.

Lamp 100 has a drive probe 120 inserted into the lamp body 102 to provide radio frequency power to the lamp body 102. In the example of FIG. 1A, the lamp also has a feedback probe 122 inserted into the lamp body 102 to sample power from the lamp body 102 and provide it as feedback to the lamp drive circuit 106. A lamp drive circuit 106 including a power supply, such as amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body, bulb and plasma) for the steady state operating conditions of the lamp. The lamp drive circuit 106 is matched to the load at the drive probe 120 using the matching network 126.

In example embodiments, radio frequency power may be provided at a frequency in the range of between about 50 MHz and about 10 GHz or any range subsumed therein. The radio frequency power may be provided to drive probe 120 at or near a resonant frequency for lamp body 102. The frequency may be selected based on the dimensions, shape and relative permittivity of the lamp body 102 to provide resonance in the lamp body 102. In example embodiments, the frequency is selected for a fundamental resonant mode of the lamp body 102, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the radio frequency power causes a light emitting plasma discharge in the bulb. In example embodiments, power is provided by RF wave coupling. In example embodiments, RF power is coupled at a frequency that forms a standing wave in the lamp body (sometimes referred to as a sustained waveform discharge or microwave discharge when using microwave frequencies). In other embodiments, a capacitively coupled or inductively coupled electrodeless plasma lamp may be used. Other high intensity discharge lamps may be used in other embodiments.

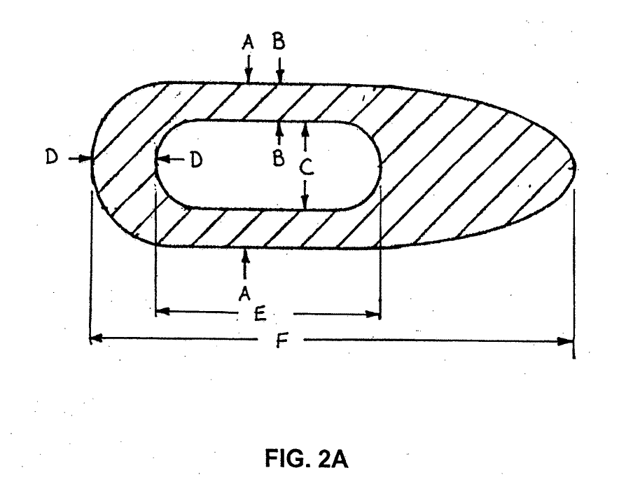

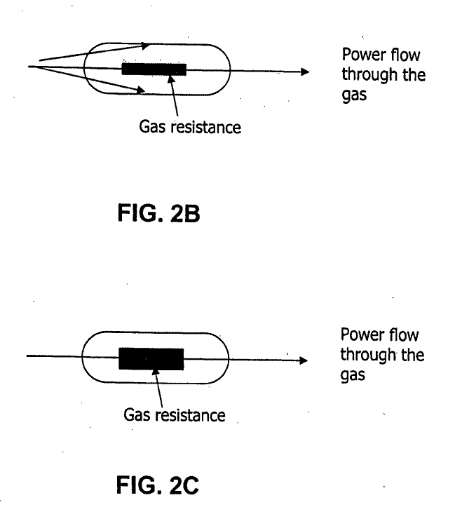

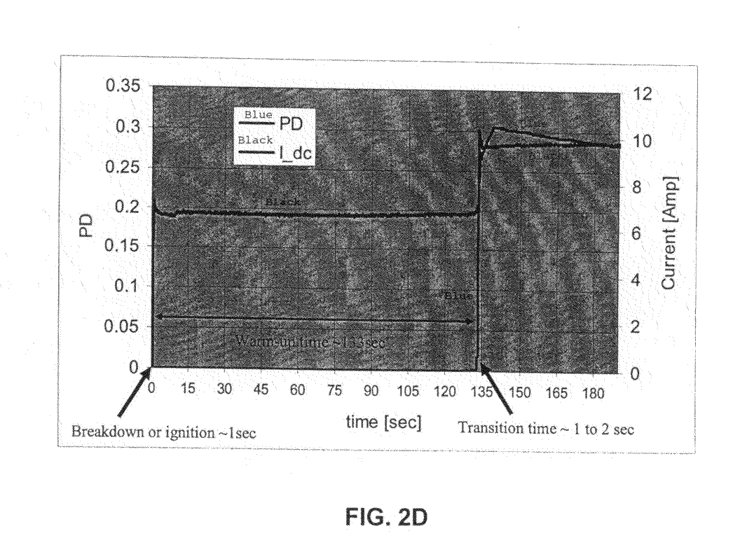

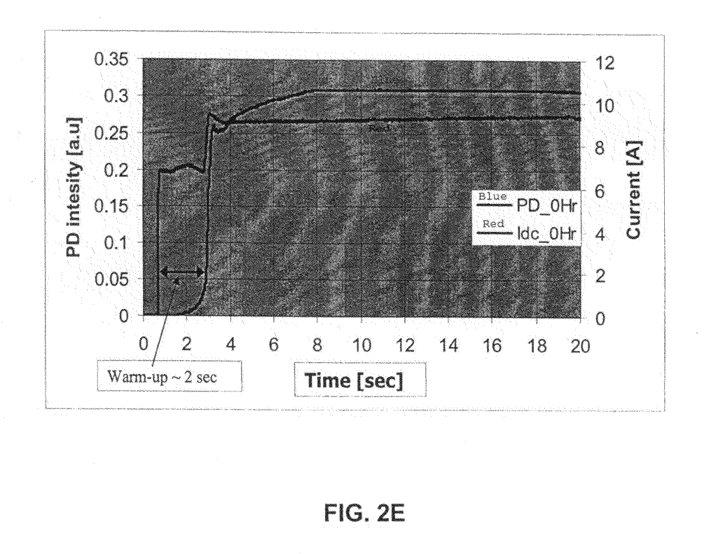

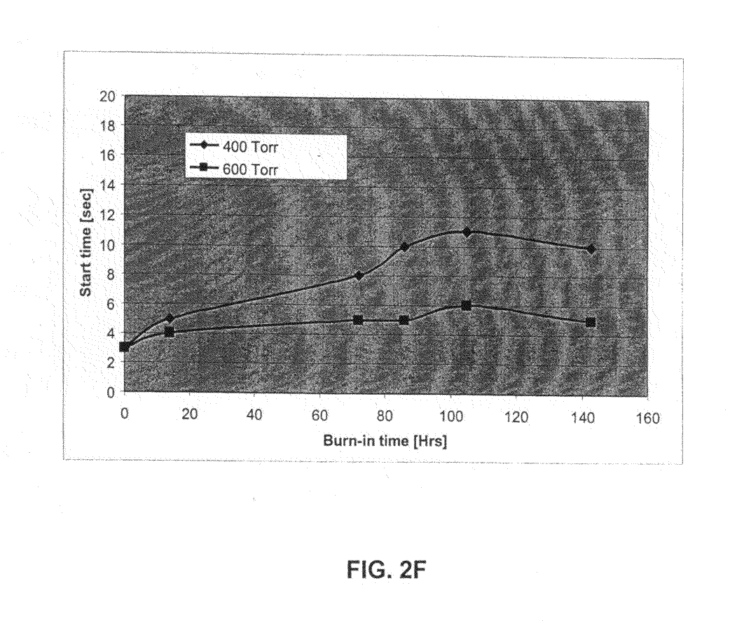

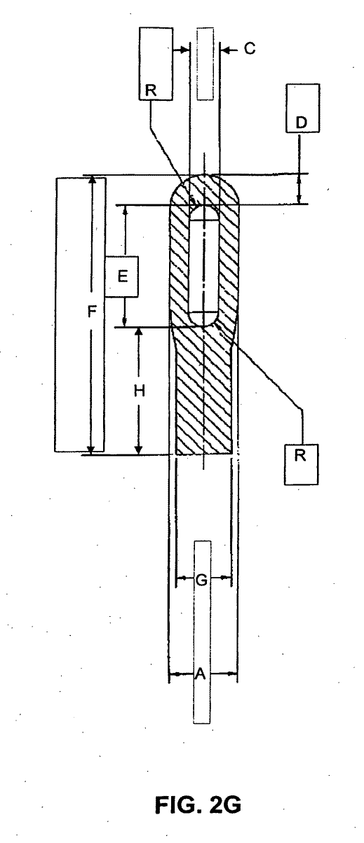

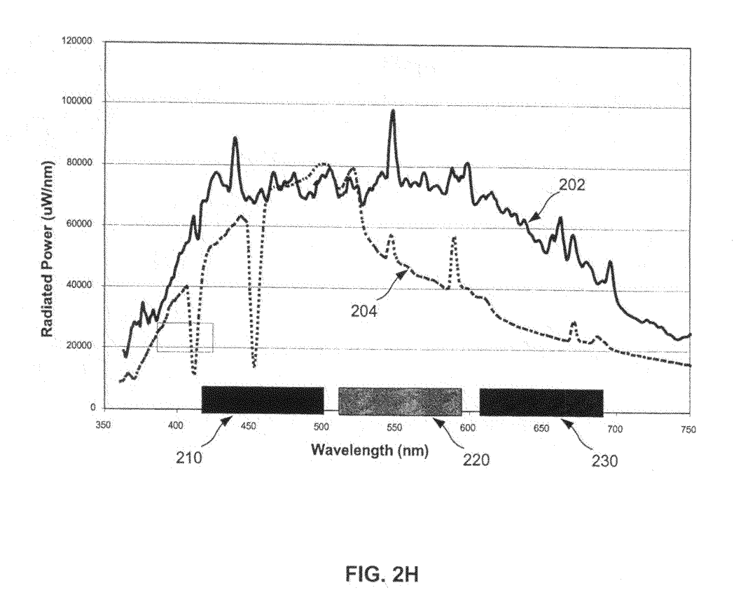

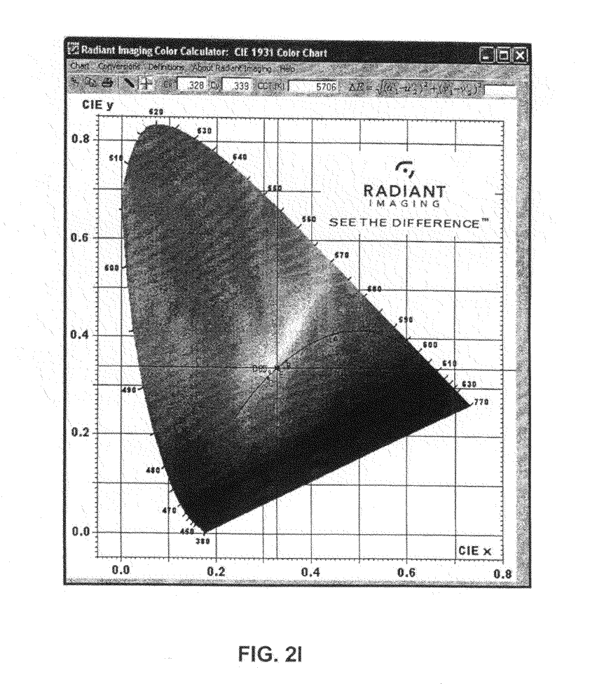

The bulb 104 may be quartz, sapphire, ceramic or other desired bulb material and may be cylindrical, pill shaped, spherical or other desired shape. In an example embodiment shown in FIG. 2A, the bulb is cylindrical in the center and forms a hemisphere at each end. In one example, the outer length F (from tip to tip) is about 15 mm and the outer diameter A (at the center) is about 5 mm. In this example, the interior of the bulb (which contains the fill) has an interior length E of about 9 mm and an interior diameter C at the center) of about 2.2 mm. The wall thickness B is about 1.4 mm along the sides of the cylindrical portion. The wall thickness D at the front end is about 2.25 mm. The wall thickness at the other end is about 3.75 mm. In this example, the interior bulb volume is about 31.42 mm³. In example embodiments where power is provided during steady state operation at between about 150-200 watts (or any range subsumed therein), this results in a power density in the range of about 4.77 watts per mm³ to 6.37 watts per mm³ (4770 to 6370 watts per cm³) or any range subsumed therein. In this example embodiment, the interior surface area of the bulb is about 62.2 mm² (0.622 cm²) and the wall loading (power over interior surface area) is in the range of about 2.41 watts per mm² to 3.22 watts per mm² (241 to 322 watts per cm²) or any range subsumed therein.

In another example embodiment, the interior of the bulb (which contains the fill) has an interior length E of about 9 mm and an interior diameter C at the center) of about 2 mm. The wall thickness B is about 1.5 mm along the sides of the cylindrical portion. The wall thickness D at the front end (through which light is transmitted out of the lamp) is about 2.25 mm. In this example embodiment, the interior bulb volume is about 26.18 mm³. The wall thickness at the other end is about 3.75 mm. In example embodiments where power is provided during steady state operation at between about 150-200 watts (or any range subsumed therein), this results in a power density in the range of about 5.73 watts per mm³ to 7.64 watts per mm³ (5730 to 7640 watts per cm³) or any range subsumed therein. In this example embodiment, the interior surface area of the bulb is about 56.5 mm² (0.565 cm²) and the wall loading (power over interior surface area) is in the range of about 2.65 watts per mm² to 3.54 watts per mm² (265 to 354 watts per cm²) or any range subsumed therein.

In another example embodiment shown in FIG. 2G, the bulb may have a tail extending from one end of the bulb. In some embodiments, the length of the tail (indicated at H in FIG. 2G) may be between about 2 mm and 25 mm or any range subsumed therein. In some example embodiments, a longer or shorter tail may be used. In one example embodiment, the length of the tail, H, is about 9.5 mm. In this example embodiment, the outer length F (from tip to tip) is about 15 mm and the outer diameter A (at the center) is about 5 mm. In this example embodiment, the interior of the bulb (which contains the fill) has an interior length E of about 9 mm and an interior diameter C at the center) of about 2.2 mm. The wall thickness B is about 1.4 mm along the sides of the cylindrical portion. The wall thickness D at the front end is about 2.25 mm. The radius R is about 1.1 mm. In this example embodiment, the interior bulb volume is about 31.42 mm³. The tail may be formed by using a quartz tube to form the bulb. The tube is sealed at one end which forms the front end of the bulb. The bulb is filled through the open end of the tube and sealed. The sealed tube is then placed in a liquid nitrogen bath and a torch is used to collapse the tube at the other end of the lamp, which seals the bulb and forms the tail. The collapsed tube is then cut for the desired tail length.

In some example embodiments, the tail may be used to align the bulb and mount it in position. For example, recess 118 may be packed with alumina powder. A plate or cement or other material may be used to cover the back of the recess 118 and hold the powder in place. This layer forms a rigid structure to which the bulb tail may be mounted and fixed in position relative to the lamp body. For example, a layer of cement may be placed across the back surface of the powder and the tail of the bulb may be placed in the cement before it is cured. The cured cement holds the bulb in place and forms a rigid layer that is fixed in position relative to the lamp body. In some example embodiments, the tail may also provide additional heat sinking to the back end of the bulb. To the extent that the dose amounts result in a condensed pool of metal halide during lamp operation, the tail helps form the pool at the cooler region at the back of the bulb, rather than at the front of the bulb through which light is transmitted out of the lamp.

In other example embodiments, the bulb may have an interior width or diameter in a range between about 2 and 30 mm or any range subsumed therein, a wall thickness in a range between about 0.5 and 4 mm or any range subsumed therein, and an interior length between about 2 and 30 mm or any range subsumed therein. In example embodiments, the interior bulb volume may range from 10 mm³ and 750 mm³ or any range subsumed therein. In some embodiments, the bulb volume is less than about 100 mm³. In example embodiments where power is provided during steady state operation at between about 150-200 watts, this results in a power density in the range of about 1.5 watts per mm³ to 2 watts per mm³ (1500 to 2000 watts per cm³) or any range subsumed therein. In this example embodiment, the interior surface area of the bulb is about 55.3 mm² (0.553 cm²) and the wall loading (power over interior surface area) is in the range of about 2.71 watts per mm² to 3.62 watts per mm² (271 to 362 watts per cm²) or any range subsumed therein. In some embodiments, the wall loading (power over interior surface area) may be 1 watts per mm² (100 watts per cm²) or more. These dimensions are examples only and other embodiments may use bulbs having different dimensions.

In example embodiments, the bulb 104 contains a fill that forms a light emitting plasma when radio frequency power is received from the lamp body 102. The fill may include a noble gas and a metal halide. Additives such as Mercury may also be used. An ignition enhancer may also be used. A small amount of an inert radioactive emitter such as Kr₈₅ may be used for this purpose. Some example embodiments may use a combination of metal halides to produce a desired spectrum and lifetime characteristics. In some example embodiments, a first metal halide is used in combination with a second metal halide. In some example embodiments, the first metal halide is Aluminum Halide, Gallium Halide, Indium Halide, Thallium Halide and Cesium Halide and the second metal halide is a halide of a metal from the Lanthanide series. In example embodiments, the does amount of the first metal halide is in the range of from about from 1 to 50 micrograms per cubic millimeter of bulb volume, or any range subsumed therein and the dose amount of the second metal halide is in the range of from about from 1 to 50 micrograms per cubic millimeter of bulb volume, or any range subsumed therein. In some embodiments, the dose of the first metal halide and the dose of the second metal halide are each in the range of from about 10 to 10,000 micrograms or any range subsumed therein. In example embodiments, these dose amount result in a condensed pool of metal halide during lamp operation. A noble gas and additives such as Mercury may also be used. In example embodiments, the dose amount of Mercury is in the range of 10 to 100 micrograms of Mercury per mm³ of bulb volume, or any range subsumed therein. In some embodiments, the dose of Mercury may be in the range of from about 0.5 to 5 milligrams or any range subsumed therein. An ignition enhancer may also be used. A small amount of an inert radioactive emitter such as Kr₈₅ may be used for this purpose. In some example embodiments, Kr₈₅ may be provided in the range of about 5 nanoCurie to 1 microCurie or any range subsumed therein.

In a particular example embodiment, the fill includes the first metal halide as an Iodide or Bromide in the range from about 0.05 mg to 0:3 mg or any range subsumed therein, and the second metal halide as an Iodide or Bromide in the range from about 0.05 mg to 0.3 mg or any range subsumed therein. Chlorides may also be used in some embodiments. In some example embodiments, the first metal halide and the second metal halide are provided in equal amounts. In other embodiments, the ratio of the first metal halide to the second metal halide may be 10:90, 20:80, 30:70, 40:60, 60:40, 70:30, 80:20 or 90:10.

In some example embodiments, the first metal halide is Aluminum Halide, Gallium Halide, Indium Halide or Thallium Halide (or a combination of Aluminum Halide, Gallium Halide, Indium Halide and/or Thallium Halide). In some example embodiments, the first metal halide may be Cesium Halide (or Cesium Halide in combination with Aluminum Halide, Gallium Halide, Indium Halide and/or Thallium Halide). In other example embodiments, the dose does not include any Alkali metals. In some example embodiments, the second metal halide is Holmium Halide, Erbium Halide or Thulium Halide (or a combination of one or more of these metal halides). In these example embodiments, the first metal halide may be provided in a dose amount in the range of about 0.3 mg/cc to 3 mg/cc or any range subsumed therein and the second metal halide may be provided in a dose amount in the range of about 0.15 mg/cc to 1.5 mg/cc or any range subsumed therein. In some example embodiments, the first metal halide may be provided in a dose amount in the range of about 0.9 mg/cc to 1.5 mg/cc or any range subsumed therein and the second metal halide may be provided in a dose amount in the range of about 0.3 mg/cc to 1 mg/cc or any range subsumed therein. In some example embodiments, the first metal halide is provided in a larger dose amount than the second metal halide. In some examples, the first metal halide is Aluminum Bromide or Indium Bromide and the second metal halide is Holmium Bromide. In some example embodiments, the fill also includes Argon or another noble gas at a pressure in the range of about 50 to 760 Torr or any range subsumed therein. In some example embodiments, the pressure is 100 Torr or more or 150 Torr or more or may be at higher pressures as described below. In one example, Argon at 150 Torr may be used. Mercury and an inert radioactive emitter such as Kr₈₅ may also be included in the fill. In some example embodiments, a power of 100 watts or more may be provided to the lamp. In some example embodiments, the power is in the range of about 150 to 200 watts, with 170 watts being used in a particular example. The wall loading may be 1 watts per mm² (100 watts per cm²) or more. A thermally conductive material, such as alumina powder, may be in contact with the bulb to allow high wall loading to be used as described below. In some example embodiments, as described further below, these fills may be used to provide 15,000 to 20,000 lumens (or any range subsumed therein) when operated at 150 to 200 watts (or any range subsumed therein). This can provide a luminous efficiency of 100 lumens per watt or more in some embodiments. Example embodiments may also provide at a correlated color temperature of 4000 to 10000 K (or any range subsumed therein) with a bulb geometry enabling the collection of 4500 to 5500 lumens (or any range subsumed therein) in 27 mm2 steradian when operated at 150 to 200 watts (or any range subsumed therein). In some example embodiments, the fill may be selected to provide a correlated color temperature in the range of 6000 to 9000 K.

Other metal halides may also be used in other example embodiments, including Bromides, Iodides and Chlorides of Indium, Aluminum, Gallium, Thallium, Holmium, Dysprosium, Cerium, Cesium, Erbium, Thulium, Lutetium and Gadolinium. Other metal halides may also be used in other embodiments, including Bromides, Iodides and Chlorides of Sodium, Calcium, Strontium, Yttrium, Tin, Antimony, Thorium and any of the elements in the Lanthanide series.

Some example embodiments may use a combination of metal halides to produce a desired spectrum. In some examples, one or more metal halides with strong emission in the blue color range (such as halides of Aluminum, Cesium, Gallium, Indium and/or Scandium) may be combined with one or more metal halides to enhance emission in the red color range (such as halides of Sodium, Calcium, Strontium, Gadolinium, Dysprosium, Holmium, Erbium and/or Thulium). In particular example embodiments, the fill may include (1) Aluminum Halide and Holmium Halide; (2) Aluminum Halide and Erbium Halide; (3) Gallium Halide and Holmium Halide; (4) Gallium Halide and Erbium Halide; (5) any of these fill further including Indium Halide; (6) any of these fills further including an alkali metal halide such as Sodium Halide or Cesium Halide (although other examples may specifically exclude all alkali metals); and (7) any of these fills further including Cerium Halide.

In an example embodiment, the metal halide(s) may be provided in the range from about 0.01 mg to 10 mg or any range subsumed therein and Mercury may be provided in the range of about 0.01 to 10 mg or any range subsumed therein. In example embodiments, the fill includes 1 to 100 micrograms of metal halide per mm³ of bulb volume, or any range subsumed therein, 1 to 100 micrograms of Mercury per mm³ of bulb volume, or any range subsumed therein, and 5 nanoCurie to 1 microCurie of a radioactive ignition enhancer, or any range subsumed therein. In other examples, the fill may include a dose of one or more metal halides in the range of about 1 to 100 micrograms of metal halide per mm³ of bulb volume without Mercury. In some embodiments using, more than one metal halide, the total dose may be in any of the above ranges and the percentage of each metal halide may range from 5% to 95% of the total dose or any range subsumed therein.

These doses are examples only and other embodiments may use different doses and/or different fill materials. In other embodiments, different fills such as Sulfur, Selenium or Tellurium may also be used. In some examples, a metal halide such as Cesium Bromide may be added to stabilize a discharge of Sulfur, Selenium or Tellurium. Metal halide may also be added to a fill of Sulfur, Selenium or Tellurium to change the spectrum of the discharge.

In some example embodiments, a high pressure fill is used to increase the resistance of the gas. This can be used to decrease the overall startup time required to reach full brightness for steady state operation. In one example, a noble gas such as Helium, Neon, Argon, Krypton or Xenon, or another substantially non-reactive gas such as Nitrogen, or a combination of these gases is provided at high pressures between 200 Torr to 3000 Torr or any range subsumed therein. Pressures less than or equal to 760 Torr may be desired in some embodiments to facilitate filling the bulb at or below atmospheric pressure. In particular embodiments, pressures between 400 Torr and 600 Torr are used to enhance starting. Example high pressure fills may also include metal halide (or a combination of metal halides as described above) and Mercury which have a relatively low vapor pressure at room temperature. Example metal halide and Mercury fills include, but are not limited to, the fills described in Table 1 below. A bulb as described in connection with FIG. 2A or FIG. 2G may be used with these fills in example embodiments. In one example, the bulb has a volume of about 31.42 mm³ as described above.

TABLE 1

| Fill | InBr | | DyI₃ | | CeI₃ | | HoBr₃ | | AlBr₃ | | ErBr₃ | | GdI₃ | | HoI₃ | | Hg |
|---|---|---|---|---|---|---|---|---|---|---|---|---|---|---|---|---|---|
| #1 | 0.1 | mg | 0.1 | mg | 0 | | 0 | | 0 | | 0 | | 0 | | 0 | | 2.7 mg |
| #2 | 0.1 | mg | 0 | | 0.1 | mg | 0 | | 0 | | 0 | | 0 | | 0 | | 2.7 mg |
| #3 | 0 | | 0 | | 0 | | 0.05 | mg | 0.05 | mg | 0 | | 0 | | 0 | | 1.35 mg |
| #4 | 0.1 | mg | 0 | | 0 | | 0 | | 0.1 | mg | 0 | | 0 | | 0 | | 2.7 mg |
| #5 | 0.1 | mg | 0 | | 0 | | 0 | | 0 | | 0 | | 0.1 | mg | 0 | | 2.7 mg |
| #6 | 0.1 | mg | 0 | | 0 | | 0 | | 0 | | 0 | | 0 | | 0.1 | mg | 2.7 mg |
| #7 | 0.1 | mg | 0 | | 0 | | 0 | | 0 | | 0 | | 0 | | 0 | | 1.6 mg |
| #8 | 0 | | 0 | | 0 | | 0 | | 0.05 | mg | 0.05 | mg | 0 | | 0 | | 1.35 mg |
| #10 | 0.03 | mg | 0 | | 0 | | 0.01 | mg | 0 | | 0 | | 0 | | 0 | | 1.4 mg |
| #11 | 0.03 | mg | 0 | | 0 | | 0.03 | mg | 0 | | 0 | | 0 | | 0 | | 1.4 mg |
| #12 | 0.05 | mg | 0 | | 0 | | 0.01 | mg | 0 | | 0 | | 0 | | 0 | | 1.4 mg |
| #13 | 0.05 | mg | 0 | | 0 | | 0.03 | mg | 0 | | 0 | | 0 | | 0 | | 1.4 mg |

In example embodiments, these dose amount result in a condensed pool of metal halide during lamp operation. These fills can also be used without Mercury in some embodiments. In these examples, Argon or Krypton is provided at a pressure in the range of about 400 Torr to 760 Torr, depending upon desired startup characteristics. Some embodiments may use higher pressures. Initial breakdown of the noble gas is more difficult at higher pressure, but the overall warm up time required for the fill to substantially vaporize and reach peak brightness is reduced. The above fills may be used with or without an ignition enhancer. In some embodiments, these fills include Kr₈₅ in the range of about 5 nanoCurie to 1 microCurie or any range subsumed therein. Higher levels of ignition enhancer can be used to provide almost instantaneous ignition. The above pressures are measured at 22° C. (room temperature). It is understood that much higher pressures are achieved at operating temperatures after the plasma is formed. For example, the lamp may provide a high intensity discharge at high pressure during operation (e.g., greater than 2 atmospheres and 10-100 atmospheres or more in example embodiments or any range subsumed therein). These pressures and fills are examples only and other pressures and fills may be used in other embodiments.

In a particular example embodiment, the bulb has a volume of about 26.18 mm cubed and the fill includes 0.05 milligram of ALBr3 and 0.05 mg of HoBr3. In another example embodiment, the bulb has a volume of about 26.18 mm cubed and the fill includes 0.05 milligram of ALBr3 and 0.05 mg of ErBr3. These fills may also include 1.35 mg of Mercury or may be Mercury free in some example embodiments. The fill may also include 10 nanoCurie of Kr₈₅. In this example embodiment, Argon or Krypton is provided at a pressure in the range of about 400 Torr to 760 Torr, depending upon desired startup characteristics. Some embodiments may use higher pressures. Initial breakdown of the noble gas is more difficult at higher pressure, but the overall warm up time required for the fill to substantially vaporize and reach peak brightness is reduced.

FIG. 2H shows an example spectral power distribution 202 for a lamp of the type shown in FIG. 1A containing the example ALBr3/HoBr3 fill in microwatts per nanometer as collected in 27 mm² steradian at 180 W operating power. FIG. 2H also shows an example spectral power distribution 204 for an Indium Bromide fill for comparison. The wavelengths in the color bands are indicated at 210 for the blue spectrum, 220 for the green spectrum and 230 for the red spectrum. As shown in FIG. 2H, the Aluminum/Holmium fill provides a brighter and more balanced spectrum. The Aluminum Halide provides enhanced blue and the Holmium Halide provides enhanced red. The fill also avoids the two absorption bands in the blue spectrum where the power drops for the Indium Bromide fill. FIG. 2I shows a color chart indicating the white point for this fill at D65. As shown in FIG. 2I, this fill has a correlated color temperature of about 5706 Kelvin and the white point is very close to the black body curve. As shown on the CIE 1931 color chart in FIG. 2I, both Cₓ and C_{y} are within 5% or less of values that would put the white point on the black body curve. In example embodiments, the bulb is provided with a fill including Aluminum Halide, Holmium Halide and Mercury in amounts selected to provide 15,000 to 20,000 lumens (or any range subsumed therein) at a correlated color temperature of 4000 to 10000 K (or any range subsumed therein) with a bulb geometry enabling the collection of 4500 to 5500 lumens (or any range subsumed therein) in 27 mm2 steradian when operated at 150 to 200 watts (or any range subsumed therein). In some example embodiments, the fill may be selected to provide a correlated color temperature in the range of 6000 to 9000 K. These doses, pressures and fills are examples only and other doses, pressures and fills may be used in other example embodiments.

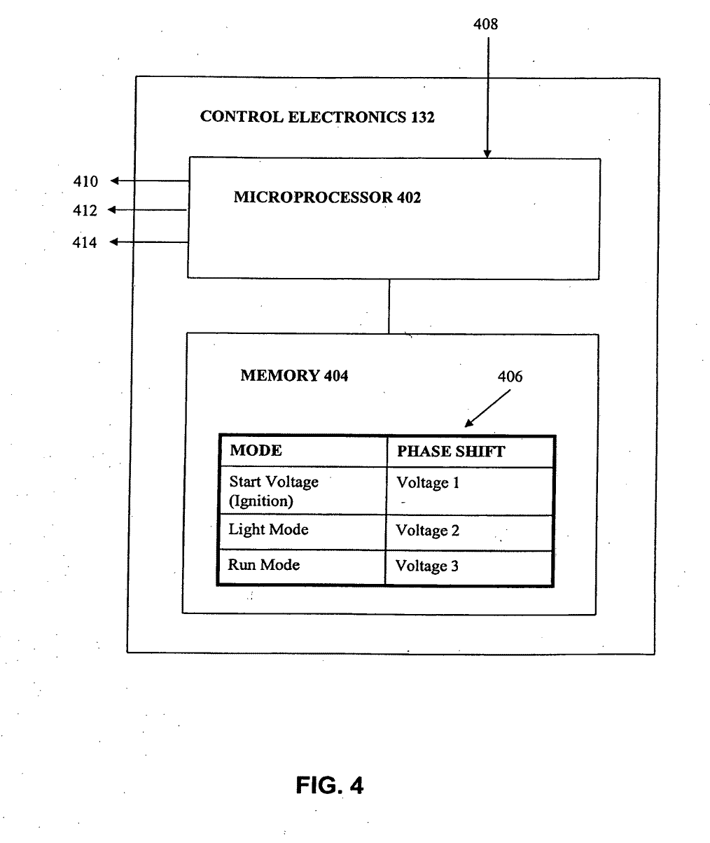

The operation of an example lamp will now be described with reference to FIG. 1A and FIG. 4. The power to the lamp body 102 may be controlled to provide a desired startup sequence for igniting the plasma. As the plasma ignites and heats up during the startup process, the impedance and operating conditions of the lamp change. In order to provide for efficient power coupling during steady state operation of the lamp, the lamp drive circuit 106 is impedance matched to the steady state load of the lamp body, bulb and plasma after the plasma is ignited and reaches steady state operating conditions. This allows power to be critically coupled from the drive circuit 106 to the lamp body 102 and plasma during steady state operation. However, the power from the drive circuit 106 is overcoupled to the lamp body 102 at ignition and during warm up of the plasma.

When the power is initially turn on, the load appears as an open circuit and the power is substantially reflected. However, the gas in the bulb ignites and breaks down almost immediately as indicated at 400 in FIG. 4. After ignition, the impedance is low and much of the power from the drive circuit 106 is reflected. For example, the amplifier 124 may provide about 170 watts of forward power, but more than half of this power may be reflected at startup. The net power to the lamp may be only between about 40-100 watts (or any range subsumed therein) after ignition and prior to substantial vaporization of the Mercury and metal halide (when the lamp transitions to high brightness), and the rest may be reflected. In other examples, 40-80%, or any range subsumed therein, of the forward power from the amplifier may be reflected during warm up.

The breakdown of the noble gas then heats the walls of the bulb, which leads to vaporization of the Mercury and metal halide as indicated at 402 in FIG. 4. Once the Mercury and metal halide is vaporized, the lamp reaches high brightness and power is more effectively coupled into the plasma. However, if the breakdown of the noble gas does not provide enough heat, vaporization of the Mercury and metal halide will be slow and the lamp will not reach full brightness quickly.

FIGS. 2A and 2B illustrate the power flow through a bulb at a low pressure of less than 200 Torr and at more than 400 Torr, respectively. In the example lamp of FIG. 1A, a TM fundamental resonant mode may be used and the resulting electric field is approximately parallel to the length of the bulb. As shown in FIGS. 2A and 2B the direction of power flow through the bulb is approximately parallel to the length of the bulb.

The bulb shown in FIG. 2A represents a bulb with a fill including Argon at a pressure of less than about 200 Torr as well as Mercury and metal halide. The impedance after breakdown is very small and is estimated to be about 1 ohm. When the net power is low, the amount of heat generated is not sufficient to increase the wall temperature to rapidly evaporate the Mercury and metal halide in the bulb. In one example with a low pressure fill, the net power during warm up is about 20 watts of less and the lamp startup may take several minutes to reach high brightness (including the time for breakdown of Argon, early warm up/vaporization of Mercury, late warm up/vaporization of metal halide and transition time). An example startup time for a low pressure fill is illustrated in FIG. 2D. As shown in FIG. 2D, the breakdown and transition time are relatively short, but the warm up time takes about 133 seconds (about 98% of the startup time). In one example, in order to achieve a desired startup time at 200 Torr, a forward power of about 244 W or more is required.

The bulb shown in FIG. 2B represents a bulb with a fill including Argon at a pressure of more than about 400 Torr as well as Mercury and Indium Bromide. The impedance after breakdown is estimated to be more than 10 times the impedance for the bulb shown in FIG. 2A (more than 10 ohms). An example startup time for a high pressure fill is illustrated in FIG. 2E. As shown in FIG. 2E, the warm up time is short and may be less than 2 seconds in some embodiments. As shown in FIG. 2E, the warm up starts upon ignition and breakdown of the noble gas and continues until the lamp transitions to high brightness. FIG. 2E shows the intensity of light output detected by a photodiode (PD) during startup. In this example, the warm up time is indicated at a photodiode intensity of about 0.06, which is about 20% of the peak output intensity. The time from ignition to the beginning of the transition curve (e.g., around 3-5% of peak intensity) is even shorter and is slightly over a second in this example. The lamp then transitions to high brightness. The transition period from warm up to 80% peak brightness in this example is about one second. In example embodiments, it is believed that ignition time can be reduced to a fraction of a second (for example, using increased ignition enhancer) and that higher pressure noble gas can be used to further reduce warm up time (e.g., to 1-2 seconds or less). As a result, it is believed that very fast startup times of 1-3 seconds may be achieved even though the net power is limited due to the impedance mismatch during startup. FIG. 2E also shows the DC current (Idc) provided by the amplifier. As shown in FIG. 2E, the DC current may be limited during warm up. This may help reduce the potential for damage to the lamp drive circuit during periods of high reflection. After transition (e.g., 80% peak brightness) in this example, the DC current is raised to a higher level. In the example of FIG. 2E, the DC current is less than 8 Amperes during warm up and more than 8 Amperes during steady state operation, even though the impedance is substantially lower during warm up (e.g., about 10 ohms) than during steady state (e.g., about 50 ohms).

FIG. 2F shows the effect of lamp burn in on start up times in example embodiments. With an example net power of about 60 watts during warm up, the startup time at 400 Torr may take only about 10 seconds and the startup time at 600 Torr may take only about 5 seconds. This startup time is measured after lamp burn-in of 72 hours or more. At pressures above 400 Torr, a sparker or other ignition aid may be used for initial ignition. Aging of the bulb may facilitate fill breakdown, and the fill may ignite without a separate ignition aid after burn-in of about 72 hours. In addition, the presence of hydrogen impurities shortens warm up time, but hydrogen diffuses out after about 72 hours. FIG. 2F to shows a chart illustrating the change in startup time for a bulb at 400 Torr and 600 Torr over burn-in period of about 140 hours. As seen in FIG. 2F, the startup time stabilizes at about 10 seconds for 400 Torr and 5 seconds for 600 Torr after burn-in.

The lamp drive circuit 106 and startup procedure for lamp 100 will now be described in further detail. As shown in FIG. 1A, the amplifier 124 may be coupled to the drive probe 120 through a matching network 126 to provide impedance matching. In an example embodiment, the amplifier 124 is matched to about 50 ohms for the steady state operating conditions of the lamp.

In example embodiments, the amplifier 124 may be operated in multiple operating modes at different bias conditions to improve starting and then to improve overall amplifier efficiency during steady state operation. For example, the amplifier may be biased to operate in Class A/B mode to provide better dynamic range during startup and in Class C mode during steady state operation to provide more efficiency. The amplifier may also have a gain control that can be used to adjust the gain of the amplifier 124. Amplifier 124 may include either a plurality of gain stages or a single stage.

The feedback probe 122 is coupled to the input of the amplifier 124 through an attenuator 128 and phase shifter 130. The attenuator 128 is used to adjust the power of the feedback signal to an appropriate level for input to the phase shifter 130. In some embodiments, a second attenuator may be used between the phase shifter 130 and the amplifier 124 to adjust the power of the signal to an appropriate level for amplification by the amplifier 124. In some embodiments, the attenuator(s) may be variable attenuators controlled by the control electronics 132. In other embodiments, the attenuators may be set to a fixed value. In some embodiments, the lamp drive circuit may not include an attenuator. In an example embodiment, the phase shifter 130 may be a voltage-controlled phase shifter controlled by the control electronics 132.

The feedback loop automatically oscillates at a frequency based on the load conditions and phase of the feedback signal. This feedback loop may be used to maintain a resonant condition in the lamp body 102 even though the load conditions change as the plasma is ignited and the temperature of the lamp changes. If the phase is such that constructive interference occurs for waves of a particular frequency circulating through the loop, and if the total response of the loop (including the amplifier, lamp, and all connecting elements) at that frequency is such that the wave is amplified rather than attenuated after traversing the loop, the loop will oscillate at that frequency. Whether a particular setting of the phase-shifter induces constructive or destructive feedback depends on frequency. The phase-shifter 128 can be used to finely tune the frequency of oscillation within the range supported by the lamp's frequency response. In doing so, it also effectively tunes how well RF power is coupled into the lamp because power absorption is frequency-dependent. Thus, the phase-shifter 128 provides fast, finely-tunable control of the lamp output intensity. Both tuning and detuning are useful. For example: tuning can be used to maximize intensity as component aging changes the overall loop phase; detuning can be used to control lamp dimming. In some example embodiments, the phase selected for steady state operation may be slightly out of resonance, so maximum brightness is not achieved. This may be used to leave room for the brightness to be increased and/or decreased by control electronics 130.

In FIG. 1A; control electronics 132 is connected to attenuator 128, phase shifter 130 and amplifier 124. The control electronics 132 provide signals to adjust the level of attenuation provided by the attenuator 128, phase of phase shifter 130, the class in which the amplifier 124 operates (e.g., Class A/B, Class B or Class C mode) and/or the gain of the amplifier 124 to control the power provided to the lamp body 102. In one example, the amplifier 124 has three stages, a pre-driver stage, a driver stage and an output stage, and the control electronics 132 provides a separate signal to each stage. (drain voltage for the pre-driver stage and gate bias voltage of the driver stage and the output stage). The drain voltage of the pre-driver stage can be adjusted to adjust the gain of the amplifier. The gate bias of the driver stage can be used to turn on or turn off the amplifier. The gate bias of the output stage can be used to choose the operating mode of the amplifier (e.g., Class A/B, Class B or Class C). Control electronics 130 can range from a simple analog feedback circuit to a microprocessor/microcontroller with embedded software or firmware that controls the operation of the lamp drive circuit. The control electronics 130 may include a lookup table or other memory that contains control parameters (e.g., amount of phase shift or amplifier gain) to be used when certain operating conditions are detected. In example embodiments, feedback information regarding the lamp's light output intensity is provided either directly by an optical sensor 134, e.g., a silicon photodiode sensitive in the visible wavelengths, or indirectly by an RF power sensor 136, e.g., a rectifier. The RF power sensor 136 may be used to determine forward power, reflected power or net power at the drive probe 120 to determine the operating status of the lamp. A directional coupler may be used to tap a small portion of the power and feed it to the RF power sensor 136. An RF power sensor may also be coupled to the lamp drive circuit at the feedback probe 122 to detect transmitted power for this purpose. In some embodiments, the control electronics 132 may adjust the phase shifter 130 on an ongoing basis to automatically maintain desired operating conditions.

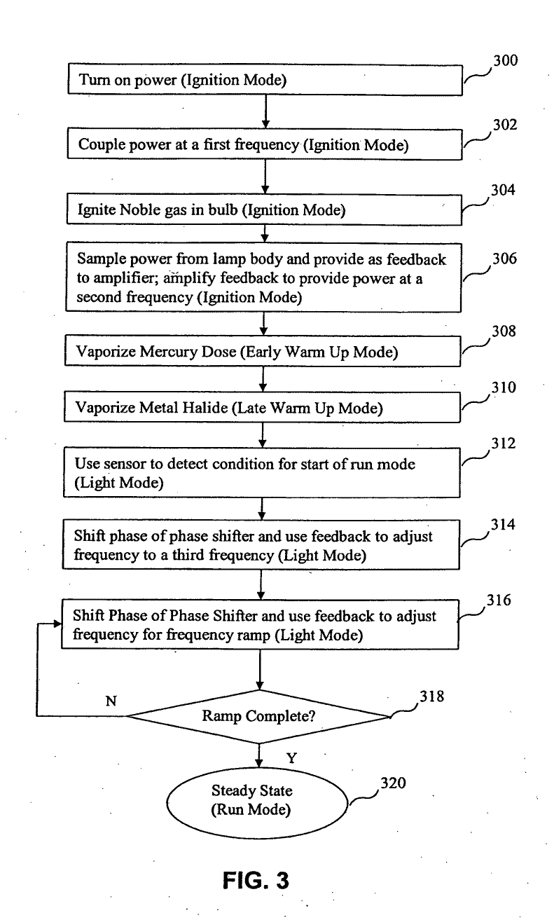

FIG. 3 is a flow chart of an example startup procedure for a fill that includes a noble gas, Mercury and metal halide. In one example, the fill includes 400-600 Torr of Argon, 1.608 mg Mercury, 0.1 mg Indium Bromide and about 10 nanoCurie of Kr₈₅. In this example, the lamp 100 starts at a frequency of about 895 MHz at power on (step 300 in FIG. 3) and the Argon ignites almost immediately (step 302 in FIG. 3). Upon ignition, the frequency drops to about 880 MHz due to the change in impedance from the ignition of the Argon. The frequency is automatically adjusted by the feedback loop as indicated at 306 in FIG. 3. The Mercury then vaporizes and heats up as indicated at 308. The Indium Bromide also vaporizes and light is emitted at high brightness as indicated at 310. When this light is detected by sensor 134, the phase shifter 130 is automatically adjusted to accommodate for the change in frequency due to the change in the impedance of the plasma as indicated at 314. In one example, the threshold may be triggered by detection of visible light output intensity in the range of from about 20%-90% of peak light output intensity. In particular examples, 80% or 90% of peak output intensity is used as a threshold. In other examples, the threshold may be determined based on forward and/or reflected power detected by the lamp drive circuit. With the appropriate phase shift, the feedback loop adjusts the frequency to about 885 MHz. In an example embodiment, when this startup process is used with a high pressure fill as described above, the startup process from power on to substantial vaporization of, the fill (steps 300 to 314 in FIG. 3) may be completed in about 5-10 seconds or less. As a result, high brightness can be achieved very rapidly.

As the plasma continues to heat up, the impedance continues to change and the frequency continues to drop until the lamp reaches steady state operating conditions. In example embodiments, the impedance after warm up is in the range of 40-60 ohms or any range subsumed therein. In a particular embodiment, the impedance is about 50 ohms during steady state operation. As the frequency changes, the phase of the phase shifter 130 may continue to be adjusted to match the changes in frequency. In an example startup procedure, the frequency ramps down to a steady state operating frequency of about 877 MHz. This ramp may take several minutes. In order to avoid a drop in brightness, the control electronics 132 adjusts the phase of the phase shifter 130 in stages to match the ramp. As shown in FIG. 4, a lookup table 406 in the control electronics 132 may be used to store a sequence of parameters indicating the amount of phase shift to be used by the control electronics 132 during the startup procedure. In one example, the voltage to be applied to the phase shifter is stored in the lookup table for startup (ignition), high (e.g., 80-90% of peak) brightness of the plasma (light mode) and steady state after the lamp is heated (run mode). A microprocessor 402 in control electronics 132 may use these parameters to shift the phase in increments between the time that transition to high brightness is detected and completion of heat up. In one example, firmware executed by the microprocessor 402 linearly interpolate between the desired phase at substantial vaporization (light mode) when the frequency is about 885 MHz and the desired phase at the end of heat up (run mode) when the frequency is about 877 MHz. In one example, firmware in the control electronics linearly interpolates sixteen values for the phase voltage that are applied in equal increments over a period of about 5 minutes as the lamp ramps from light mode to run mode. The phase adjustments and ramp may be determined empirically and programmed into the lookup table based on the operating conditions of the particular lamp. In order to adjust the phase, the microprocessor 402 outputs a voltage signal on a control line 410 which is connected to the phase shifter 130 (the other control lines 412 and 414 may be used to control the attenuator 126 and the amplifier 124). The phase adjustments continue in sequence until the ramp is complete as indicated at 318 in FIG. 3.

In an alternative embodiment, the control electronics 132 may automatically shift the phase periodically to determine whether a change in one direction or another results in more efficient power coupling and/or higher brightness (based on feedback from an optical sensor or rf power sensor in the drive circuit). This periodic phase shift can be performed very rapidly, so an observer does not notice any visible change in the light output intensity.

The phase of the phase shifter 130 and/or gain of the amplifier 124 may also be adjusted after startup to change the operating conditions of the lamp. For example, the power input to the plasma in the bulb 104 may be modulated to modulate the intensity of light emitted by the plasma. This can be used for brightness adjustment or to modulate the light to adjust for video effects in a projection display. For example, a projection display system may use a microdisplay that controls intensity of the projected image using pulse-width modulation (PWM). PWM achieves proportional modulation of the intensity of any particular pixel by controlling, for each displayed frame, the fraction of time spent in either the “ON” or “OFF” state. By reducing the brightness of the lamp during dark frames of video, a larger range of PWM values may be used to distinguish shades within the frame of video. The brightness of the lamp may also be modulated during particular color segments of a color wheel for color balancing or to compensate for green snow effect in dark scenes by reducing the brightness of the lamp during the green segment of the color wheel.

In another example, the phase shifter 130 can be modulated to spread the power provided by the lamp circuit 106 over a larger bandwidth. This can reduce ElectroMagnetic Interference (EMI) at any one frequency and thereby help with compliance with FCC regulations regarding EMI. In example embodiments, the degree of spectral spreading may be from 5-30% or any range subsumed therein. In one example, the control electronics 132 may include circuitry to generate a sawtooth voltage signal and sum it with the control voltage signal to be applied to the phase shifter 130. In another example, the control electronics 132 may include a microcontroller that generates a Pulse Width Modulated (PWM) signal that is passed through an external low-pass filter to generate a modulated control voltage signal to be applied to the phase shifter 130. In example embodiments, the modulation of the phase shifter 130 can be provided at a level that is effective in reducing EMI without any significant impact on the plasma in the bulb.

In example embodiments, the amplifier 124 may also be operated at different bias conditions during different modes of operation for the lamp. The bias condition of the amplifier 124 has a large impact on DC-RF efficiency. For example, an amplifier biased to operate in Class C mode is more efficient than an amplifier biased to operate in Class B mode, which in turn is more efficient than an amplifier biased to operate in Class A/B mode. However, an amplifier biased to operate in Class A/B mode has a better dynamic range than an amplifier biased to operate in Class B mode, which in turn has better dynamic range than an amplifier biased to operate in Class C mode.

In one example, when the lamp is first turned on, amplifier 124 is biased in a Class A/B mode. Class A/B provides better dynamic range and more gain to allow amplifier 124 to ignite the plasma and to follow the resonant frequency of the lamp as it adjusts during startup. Once the plasma reaches its steady state operating condition (run mode), the amplifier bias is removed which puts amplifier 124 into a Class C mode. This provides improved efficiency. However, the dynamic range in Class C mode may not be sufficient when the brightness of the lamp is modulated below a certain level (e.g., less than 70% of full brightness). When the brightness is lowered below the threshold, the amplifier 124 may be changed back to Class A/B mode. Alternatively, Class B mode may be used in some embodiments.

Additional aspects of electrodeless plasma lamps according to example embodiments will now be described with reference to FIGS. 1A, 1B and 1C. In example embodiments, the lamp body 102 has a relative permittivity greater than air. The frequency required to excite a particular resonant mode in the lamp body 102 generally scales inversely to the square root of the relative permittivity (also referred to as the dielectric constant) of the lamp body. As a result, a higher relative permittivity results in a smaller lamp body required for a particular resonant mode at a given frequency of power. The shape and dimensions of the lamp body 102 also affect the resonant frequency as described further below. In an example embodiment, the lamp body 102 is formed from solid alumina having a relative permittivity of about 9.2. In some embodiments, the dielectric material may have a relative permittivity in the range of from 2 to 100 or any range subsumed therein, or an even higher relative permittivity. In some embodiments, the body may include more than one such dielectric material resulting in an effective relative permittivity for the body within any of the ranges described above. The body may be rectangular, cylindrical or other shape as described further below.

In example embodiments, the outer surfaces of the lamp body 102 may be coated with an electrically conductive coating 108, such as electroplating or a silver paint or other metallic paint which may be fired onto the outer surface of the lamp body. The electrically conductive material 108 may be grounded to form a boundary condition for the radio frequency power applied to the lamp body 102. The electrically conductive coating helps contain the radio frequency power in the lamp body. Regions of the lamp body may remain uncoated to allow power to be transferred to or from the lamp body. For example, the bulb 104 may be positioned adjacent to an uncoated portion of the lamp body to receive radio frequency power from the lamp body. A high breakdown material, such as a layer of glass frit, may be coated on the outside of the electrically conductive coating 108 to prevent arcing, including the edges of the conductive material that are spaced a few millimeters from one another by surfaces 114 of the lamp body 102.

In the example embodiment of FIG. 1A, an opening 110 extends through a thin region 112 of the lamp body 102. The surfaces 114 of the lamp body 102 in the opening 110 are uncoated and at least a portion of the bulb 104 may be positioned in the opening 110 to receive power from the lamp body 102. In example embodiments, the thickness H2 of the thin region 112 may range from 1 mm to 10 mm or any range subsumed therein and may be less than the outside length and/or interior length of the bulb. One or both ends of the bulb 104 may protrude from the opening 110 and extend beyond the electrically conductive coating 108 on the outer surface of the lamp body. This helps avoid damage to the ends of the bulbs from the high intensity plasma formed adjacent to the region where power is coupled from the lamp body. In other embodiments, all or a portion of the bulb may be positioned in a cavity extending from an opening on the outer surface of the lamp body and terminating in the lamp body. In other embodiments, the bulb may be positioned adjacent to an uncoated outer surface of the lamp body or in a shallow recess formed on the outer surface of the waveguide body. In some example embodiments, the bulb may be positioned at or near an electric field maxima for the resonant mode excited in the lamp body.

A layer of material 116 may be placed between the bulb 104 and the dielectric material of lamp body 102. In example embodiments, the layer of material 116 may have a lower thermal conductivity than the lamp body 102 and may be used to optimize thermal conductivity between the bulb 104 and the lamp body 102. In an example embodiment, the layer 116 may have a thermal conductivity in the range of about 0.5 to 10 watts/meter-Kelvin (W/mK) or any range subsumed therein. For example, alumina powder with 55% packing density (45% fractional porosity) and thermal conductivity in a range of about 1 to 2 watts/meter-Kelvin (W/mK) may be used. In some embodiments, a centrifuge may be used to pack the alumina powder with high density. In an example embodiment, a layer of alumina powder is used with a thickness D5 within the range of about ⅛ mm to 1 mm or any range subsumed therein. Alternatively, a thin layer of a ceramic-based adhesive or an admixture of such adhesives may be used. Depending on the formulation, a wide range of thermal conductivities is available. In practice, once a layer composition is selected having a thermal conductivity close to the desired value, fine-tuning may be accomplished by altering the layer thickness. Some example embodiments may not include a separate layer of material around the bulb and may provide a direct conductive path to the lamp body. Alternatively, the bulb may be separated from the lamp body by an air-gap (or other gas filled gap) or vacuum gap.

In some example embodiments, alumina powder or other material may also be packed into a recess 118 formed below the bulb 104. In the example shown in FIG. 1A, the alumina powder in the recess 118 is outside the boundaries of the waveguide formed by the electrically conductive material 108 on the surfaces of the lamp body 102. The material in the recess 118 provides structural support, reflects light from the bulb and provides thermal conduction. One or more heat sinks may also be used around the sides and/or along the bottom surface of the lamp body to manage temperature. Thermal modeling may be used to help select a lamp configuration providing a high peak plasma temperature resulting in high brightness, while remaining below the working temperature of the bulb material. Example thermal modeling software includes the TAS software package available commercially from Harvard Thermal, Inc. of Harvard, Mass.

In an example embodiment, the probes 120 and 122 may be brass rods glued into the lamp body using silver paint. In other embodiments, a sheath or jacket of ceramic or other material may be used around the bulbs, which may change the coupling to the lamp body. In an example embodiment, a printed circuit board (pcb) may be positioned transverse to the lamp body for the drive electronics. The probes 120 and 122 may be soldered to the pcb and extend off the edge of the pcb into the lamp body (parallel to the pcb and orthogonal to the lamp body). In other embodiments, the probes may be orthogonal to the pcb or may be connected to the lamp drive circuit through SMA connectors or other connectors. In an alternative embodiment, the probes may be provided by a pcb trace and portions of the pcb board containing the trace may extend into the lamp body. Other radio frequency feeds may be used in other embodiments, such as microstrip lines or fine line antennas.

In an example embodiment, the drive probe 120 is positioned closer to the bulb in the center of the lamp body than the electrically conductive material 108 around the outer circumference of the lamp body 102. This positioning of the drive prove 120 can be used to improve coupling of power to the plasma in the bulb 104.

An amplifier 124 is used to provide radio frequency power to the drive probe 120. A high efficiency amplifier may have some unstable regions of operation. The amplifier 124 phase shift imposed by the feedback loop of the lamp circuit 106 should be configured so that the amplifier operates in stable regions even as the load condition of the lamp changes. The phase shift imposed by the feedback loop is determined by the length of the loop (including matching network 126) and any phase shift imposed by circuit elements such as a phase shifter 130. At initial startup before the noble gas in the bulb is ignited, the load appears to the amplifier as an open circuit. The load characteristics change as the noble gas ignites, the fill vaporizes and the plasma heats up to steady state operating conditions. The amplifier and feedback loop are designed so the amplifier will operate within stable regions across the load conditions that may be presented by the lamp body and plasma. The amplifier 124 may include impedance matching elements such as resistive, capacitive and inductive circuit elements in series and/or in parallel. Similar elements may be used in the matching network. In one example embodiment, the matching network is formed from a selected length of pcb trace that is included in the lamp drive circuit between the amplifier 124 and the drive probe 120. These elements are selected both for impedance matching and to provide a phase shift in the feedback loop that keeps the amplifier within stable regions of its operation. A phase shifter 130 may be used to provide additional phase shifting as needed to keep the amplifier in stable regions.

The amplifier 124 and phase shift in the feedback loop may be designed by looking at the reflection coefficient Γ, which is a measure of the changing load condition over the various phases of lamp operation, particularly the transition from cold gas at start-up to hot plasma at steady state. Γ, defined with respect to a reference plane at the amplifier output, is the ratio of the “reflected” electric field Eᵢₙ heading into the amplifier, to the “outgoing” electric field Eₒᵤₜ traveling out. Being a ratio of fields, Γ is a complex number with a magnitude and phase. A useful way to depict changing conditions in a system is to use a “polar-chart” plot of Γ's behavior (termed a “load trajectory”) on the complex plane. Certain regions of the polar chart may represent unstable regions of operation for the amplifier 124. The amplifier 124 and phase shift in the feedback loop should be designed so the load trajectory does not cross an unstable region. The load trajectory can be rotated on the polar chart by changing the phase shift of the feedback loop (by using the phase shifter 130 and/or adjusting the length of the circuit loop formed by the lamp drive circuit to the extent permitted while maintaining the desired impedance matching. The load trajectory can be shifted radially by changing the magnitude (e.g., by using an attenuator).

High frequency simulation software may be used to help select the materials and shape of the lamp body and electrically conductive coating to achieve desired resonant frequencies and field intensity distribution in the lamp body. Simulations may be performed using software tools such as HFSS, available from Ansoft, Inc. of Pittsburgh, Pa., and FEMLAB, available from COMSOL, Inc. of Burlington, Mass. to determine the desired shape of the lamp body, resonant frequencies and field intensity distribution. The desired properties may then be fine-tuned empirically.

While a variety of materials, shapes and frequencies: may be used, one example embodiment has a lamp body 102 designed to operate in a fundamental TM resonant mode at a frequency of about 880 MHz (although the resonant frequency changes as lamp operating conditions change as described further below). In this example, the lamp has an alumina lamp body 102 with a relative permittivity of 9.2. The lamp body 102 has a cylindrical outer surface as shown in FIG. 1B with a recess 118 formed in the bottom surface. In an alternative embodiment shown in FIG. 1C, the lamp body 102 may have a rectangular outer surface. The outer diameter D1 of the lamp body 102 in FIG. 1B is about 40.75 mm and the diameter D2 of the recess 118 is about 8 mm. The lamp body has a height H1 of about 17 mm. A narrow region 112 forms a shelf over the recess 118. The thickness H2 of the narrow region 112 is about 2 mm. As shown in FIG. 1A, in this region of the lamp body 102 the electrically conductive surfaces on the lamp body are only separated by the thin region 112 of the shelf. This results in higher capacitance in this region of the lamp body and higher electric field intensities. This shape has been found to support a lower resonant frequency than a solid cylindrical body having the same overall diameter D1 and height H1 or a solid rectangular body having the same overall width and height. For example, in some embodiments, the relative permittivity is in the range of about 9-15 or any range subsumed therein, the frequency of the RF power is less than about 1 GHz and the volume of the lamp body is in the range of about 10 cm³ to 30 cm³ or any range subsumed therein.

In this example, a hole 110 is formed in the thin region 112. The hole has a diameter of about 5.5 mm and the bulb has an outer diameter of about 5 mm. The shelf formed by the thin region 112 extends radially from the edge of the hole 110 by a distance D3 of about 1.25 mm. Alumina powder is packed between the bulb and the lamp body and forms a layer having a thickness D5 of about ¼ mm. The bulb 104 has an outer length of about 15 mm and an interior length of about 9 mm. The interior diameter at the center is about 2.2 mm and the side walls have a thickness of about 1.4, mm. The bulb protrudes from the front surface of the lamp body by about 4.7 mm. The bulb has a high pressure fill of Argon, Kr₈₅, Mercury and Indium Bromide as described above. At pressures above 400 Torr, a sparker or other ignition aid may be used for initial ignition. Aging of the bulb may facilitate fill breakdown, and the fill may ignite without a separate ignition aid after burn-in of about 72 hours.

In this example, the drive probe 120 is about 15 mm long with a diameter of about 2 mm. The drive probe 120 is about 7 mm from the central axis of the lamp body and a distance D4 of about 3 mm from the electrically conductive material 108 on the inside surface of recess 118. The relatively short distance from the drive probe 120 to the bulb 104 enhances coupling of power. The feedback probe 122 is a distance D6 of about 11 mm from the electrically conductive material 108. In one example, a 15 mm hole is drilled for the feedback probe 122 to allow the length and coupling to be adjusted. The unused portion of the hole may be filled with PTFE (Teflon) or another material. In this example, the feedback probe 122 has a length of about 3 mm and a diameter of about 2 mm. In another embodiment where the length of the hole matches the length of the feedback probe 122, the length of the feedback probe 122 is about 1.5 mm.

In this example, the bulb is positioned adjacent to narrow region 112 where the electric field of the radio frequency power in the lamp body is at a maximum. In this example, the drive probe 120 and feedback probe 122 are not positioned at a maxima or minima of the electric field of the radio frequency power in the lamp body. In example embodiments, the position of the probes may be selected for desired power coupling and impedance matching.

In this example, the lamp drive circuit 106 includes an attenuator 128, phase shifter 130, amplifier 124, matching network 126 and control electronics 132 such as a microprocessor or microcontroller that controls the drive circuit. A sensor 134 detects the intensity of light emitted by the bulb 104 and provides this information to the control electronics 132 to control the drive circuit 132. In an alternative embodiment, an RF power sensor 136 may be used to determine forward, reflected or net power to be used by the control electronics to control the drive circuit.

The above dimensions, shape, materials and operating parameters are examples only and other embodiments may use different dimensions, shape, materials and operating parameters.

1. An electrodeless plasma lamp comprising:
a lamp body comprising at least one solid dielectric material;
a radio frequency (RF) feed configured to couple RF power into the lamp body;
a bulb adjacent to the lamp body, the bulb containing a fill that forms a plasma when the RF power is coupled to the fill from the lamp body;
an electrically conductive material forming an electromagnetic boundary adjacent to an outer surface of the dielectric material; and
at least one surface of the solid dielectric material adjacent to the bulb where the electrically conductive material does not form an electromagnetic boundary and through which RF power is coupled from the lamp body to the fill in the bulb the bulb having an outer surface area, the surface of the solid dielectric material adjacent to the bulb having a surface area that is less than one half of the outer surface area of the bulb; and
wherein the fill includes a gas at a pressure greater than 200 Torr at 22° C. and at least one metal halide.

2.-92. (canceled)

93. The electrodeless plasma lamp of claim 1, wherein the fill includes a noble gas and a metal halide.

94. The electrodeless plasma lamp of claim 1, wherein the fill includes an inert radioactive emitter to be used as an ignition enhancer.

95. The electrodeless plasma lamp of claim 94, wherein the radioactive emitter is Krypton 85.

96. The electrodeless plasma lamp of claim 1, wherein the fill includes indium bromide in a dose range of between about 0.02 mg and 0.9 mg.

97. The electrodeless plasma lamp of claim 1, wherein the fill includes holmium bromide in a dose range of less than about 0.9 mg.

98. The electrodeless plasma lamp of claim 1, wherein the fill includes thulium bromide in a dose range of less than about 1.2 mg.

99. The electrodeless plasma lamp of claim 1, wherein the fill includes argon gas at a pressure between about 50 Torr and 300 Torr.

100. The electrodeless plasma lamp of claim 1, wherein the fill includes mercury in a dose range of between about 1 mg and 10 mg.

101. The electrodeless plasma lamp of claim 1, wherein the bulb has an interior volume of between about 10 mm³ and 750 mm³.

102. The electrodeless plasma lamp of claim 1, wherein the bulb has an interior volume of about 31 mm³.

103. An electrodeless plasma lamp comprising:
an electrodeless bulb; and
a source of radio frequency (RF) power configured to provide radio frequency power to the electrodeless bulb, the bulb having a wall loading of at least 100 watts per cm², the electrodeless bulb containing a fill that forms a plasma when the radio frequency power is coupled to the fill, the fill including a first metal halide and a second metal halide, the first metal halide and the second metal halide each selected from a group consisting of bromides in a dosage range between about 0.02 mg and 0.9 mg.

104. The electrodeless plasma lamp of claim 103, wherein the fill includes an inert radioactive emitter to be used as an ignition enhancer.

105. The electrodeless plasma lamp of claim 104, wherein the radioactive emitter is Krypton 85.

106. The electrodeless plasma lamp of claim 103, wherein the fill includes indium bromide in a dose range of between about 0.02 mg and 0.9 mg.

107. The electrodeless plasma lamp of claim 103, wherein the fill includes holmium bromide in a dose range of less than about 0.9 mg.

108. The electrodeless plasma lamp of claim 103, wherein the fill includes thulium bromide in a dose range of less than about 1.2 mg.

109. The electrodeless plasma lamp of claim 103, wherein the fill includes argon gas at a pressure between about 50 Torr and 300 Torr.

110. The electrodeless plasma lamp of claim 103, wherein the fill includes mercury in a dose range of between about 1 mg to 10 mg.

111. The electrodeless plasma lamp of claim 103, wherein the bulb has an interior volume of between about 10 mm³ and 750 mm³.

112. The electrodeless plasma lamp of claim 103, wherein the bulb has an interior volume of between about 172 mm³ and 367 mm³.
